(19) United States
(12) Patent Application Publication
(10) Pub. No.: US 2025/0145095 A1
(43) Pub. Date: May 8, 2025

(54) CONTROL APPARATUS FOR A VEHICLE TRAIN AND METHODS THEREFOR

(71) Applicant: Bendix Commercial Vehicle Systems LLC, Avon, OH (US)

(72) Inventors: Owen M. Porpora, Wadsworth, OH (US); Michael D. Cremona, Lakewood, OH (US); Timothy J. Frashure, Columbia Station, OH (US); Dale B. Garrett, Avon, OH (US); Kritika Singhvi, Avon, OH (US); William R. Plow, Avon, OH (US)

(21) Appl. No.: 18/503,648

(22) Filed: Nov. 7, 2023

(51) Int. Cl. B60R 16/03; B62D 53/00

(52) U.S. Cl. CPC B60R 16/03; B62D 53/005; B60L 2200/28

(57) ABSTRACT

A control apparatus is provided for a vehicle train having a tractor and first and second towed vehicles in tow by the tractor. The control apparatus comprises a first controller associated with the first towed vehicle and arranged to (i) measure voltage of a power line in vicinity of the first towed vehicle, and (ii) transmit the measured voltage along a communication line to other controllers of the vehicle train.

### BACKGROUND

The present application relates to vehicle trains, and is particularly directed to a control apparatus for a vehicle train and methods therefor, such as for a vehicle train having a tractor and a plurality of towed vehicles in tow by the tractor.

In a typical vehicle train having a tractor and a plurality of towed vehicles in tow by the tractor, each of the plurality of towed vehicles has an associated controller that communicates with a controller of the tractor. Each towed vehicle controller provides towed vehicle information related to its respective towed vehicle. The tractor controller processes the towed vehicle information from the towed vehicles, and provides vehicle control functions based upon the processed information.

Despite advances already made, those skilled in the art continue with research and development efforts in the field of communications between members of a vehicle train, such as a vehicle train having a tractor and a plurality of towed vehicles in tow by the tractor.

### SUMMARY

In accordance with one embodiment, a control apparatus is provided for a vehicle train having a tractor and first and second towed vehicles in tow by the tractor. The control apparatus comprises a first controller associated with the first towed vehicle and arranged to (i) measure voltage of a power line in vicinity of the first towed vehicle, and (ii) transmit the measured voltage along a communication line to other controllers of the vehicle train.

In accordance with another embodiment, a multiple-trailer combination of a tractor-trailer vehicle comprises a power line and a communication line. The multiple-trailer combination of a tractor-trailer vehicle also comprises a first towed vehicle including a first processor connected to the power line and connected to the communication line. The multiple-trailer combination of a tractor-trailer vehicle further comprises a second towed vehicle including a second processor connected to the power line and connected to the communication line. Each of the first and second processors is programmed to (i) measure voltage of the power line in vicinity of its respective towed vehicle, and (ii) transmit the measured voltage across the communication line to the processor of the other towed vehicle.

In accordance with yet another embodiment, a method is provided of operating a vehicle train having a tractor and a plurality of towed vehicles in tow by the tractor. The method comprises measuring a voltage of a power line in vicinity of a first towed vehicle of the plurality of towed vehicles. The method also comprises transmitting an identifier associated with the first towed vehicle and the measured voltage in vicinity of the first towed vehicle along a communication line to a second towed vehicle of the plurality towed vehicles.

### BRIEF DESCRIPTION OF THE DRAWINGS

FIG. 1 is a pictorial diagram of a vehicle train embodying an example control apparatus constructed in accordance with the present disclosure.

FIG. 1A is a schematic block diagram of the control apparatus shown in FIG. 1.

FIG. 2 is a schematic block diagram of an example tractor controller used in the control apparatus of FIG. 1A.

FIG. 3 is a schematic block diagram of an example towed vehicle controller used in the control apparatus of FIG. 1A.

FIG. 4 is a flow diagram depicting a method of operating the towed vehicle controller of FIG. 3 in accordance with an embodiment.

FIG. 5 is a flow diagram depicting a method of operating the tractor controller of FIG. 2 in accordance with an embodiment.

FIG. 6 is a flow diagram depicting a method of operating the vehicle train of FIG. 1 in accordance with an embodiment.

### DETAILED DESCRIPTION

The present application is directed to a control apparatus for a vehicle train and methods therefor, such as for a vehicle train having a tractor and a plurality of towed vehicles in tow by the tractor. The specific construction of the control apparatus may vary. It is to be understood that the disclosure below provides a number of embodiments or examples for implementing different features of various embodiments. Specific examples of components and arrangements are described to simplify the present disclosure. These are merely examples and are not intended to be limiting.

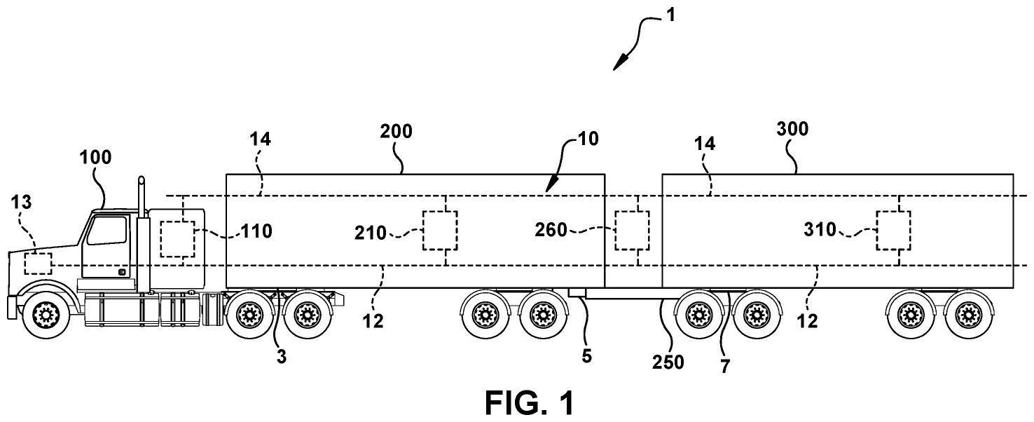

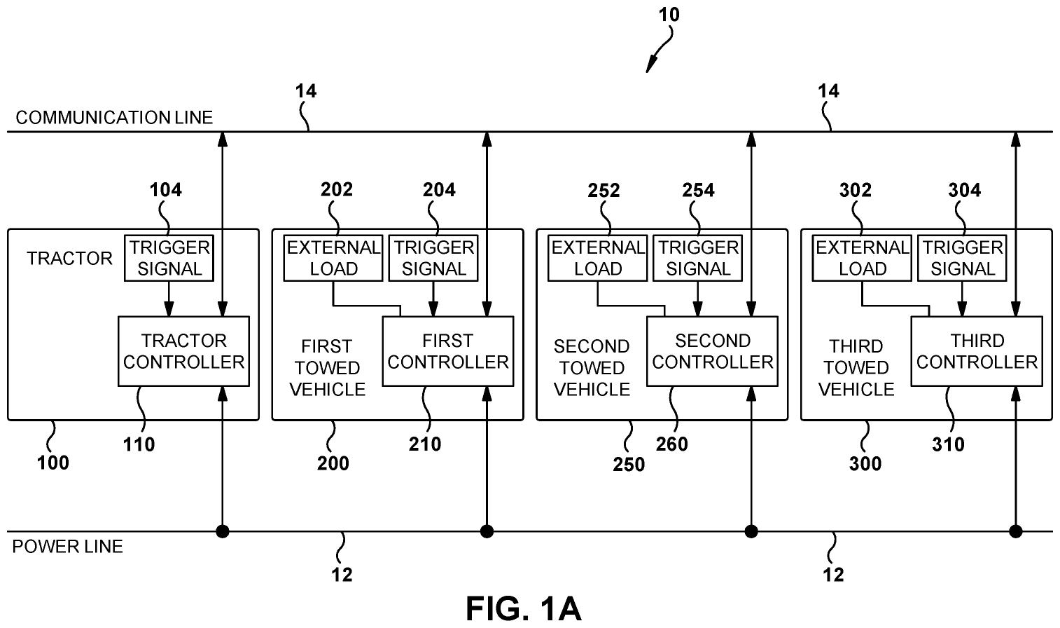

Referring to FIG. 1, a pictorial diagram is illustrated of a vehicle train 1 embodying an example control apparatus 10 constructed in accordance with the present disclosure. The vehicle train 1 has a tractor 100 and a plurality of towed vehicles including first trailer 200, dolly 250, and second trailer 300 in tow by the tractor 100. A mechanical coupling 3 mechanically interconnects the tractor 100 and the first trailer 200 in known and conventional manner. The dolly 250 includes a hook portion 5 that connects to rear end of the first trailer 200, and a plate portion 7 that connects to front end of the second trailer 300. The dolly 250 mechanically interconnects the first trailer 200 and the second trailer 300 in known and conventional manner.

Although the above description describes three towed vehicles (i.e., the first trailer 200, the dolly 250, and the second trailer 300) towed by the tractor 100, it is conceivable that any number of towed vehicles can be towed by the tractor 100. As an example, five towed vehicles (i.e., three trailers and two dollies) may be towed by the tractor 100.

The control apparatus 10 includes an electronic controller unit (ECU) 110 of the tractor 100, an ECU 210 of the first trailer 200, an ECU 260 of the dolly 250, and an ECU 310 of the second trailer 300. The ECU 110 is referred to herein as “the tractor controller 110”, the ECU 210 is referred to herein as “the first controller 210” or “the first towed controller 210”, the ECU 260 is referred to herein as “the second controller 260” or “the second towed controller 260”, and the ECU 310 is referred to herein as “the third controller 310” or “the third towed controller 310”. Each of the controllers 110, 210, 260, 310 is connected to a power line 12, and is connected to a communication line 14. The power line 12 may be connected to vehicle battery 13.

The communication line 14 may comprise a controller area network (CAN) bus to which a number of vehicle devices are connected to communicate with each other. The CAN bus may be in a standardized serial communication format, such as SAE J1939, or in a proprietary format. The communication line 14 creates a communication path through tractor and trailers that may or may not be shown or described herein via wired (e.g., controller area network (CAN), ethernet, automotive ethernet, etc.) or wireless (e.g., WiFi, Bluetooth, cellular, etc.) connections. In the example in FIG. 1, the components are directly or indirectly connected via the communication line 14, which can take the form of a controller area network (e.g., J1939, ISO 11992, or proprietary format). Other types of network communication are possible. It is also conceivable that the power line 12 may comprise the communication line 14. This is known as power line communication in which the power line 12 carries data in addition to delivering electric power to electronic components and devices.

Referring to FIG. 1A, a schematic block diagram of the control apparatus 10 shown in FIG. 1 is illustrated. The tractor controller 110 is responsive to a trigger signal 104 that may be provided from a driver-operable switch (not shown) located in the driver compartment of the tractor 100. The vehicle driver operates the switch to provide the trigger signal 104 to obtain a ranking of the order of the plurality of towed vehicles including the first trailer 200, the dolly 250, and the second trailer 300 in tow by the tractor 100, as will be described later.

The first controller 210 is connectable to an external load 202 to which voltage from the power line 12 in vicinity of the first controller 210 can be applied. The external load 202 may comprise an energizeable solenoid, for example, in which the solenoid is energized to provide a temporary load. Other types of loads are possible. The first controller 210 is responsive to a trigger signal 204 that may comprise the trigger signal 104 from the tractor 100, or alternatively, from a processor within the first controller 210 as will be described later.

The second controller 260 is connectable to an external load 252 to which voltage from the power line 12 in vicinity of the second controller 260 can be applied. The external load 252 may comprise a solenoid-type of load, for example. Other types of loads are possible. The second controller 260 is responsive to a trigger signal 254 that may comprise the trigger signal 104 from the tractor 100, or alternatively, from a processor within the second controller 260 as will be described later.

Similarly, the third controller 310 is connectable to an external load 302 to which voltage from the power line 12 in vicinity of the third controller 310 can be applied. The external load 302 may comprise a solenoid-type of load, for example. Other types of loads are possible. The third controller 310 is responsive to a trigger signal 304 that may comprise the trigger signal 104 from the tractor 100, or alternatively, from a processor within the third controller 310 as will be described later.

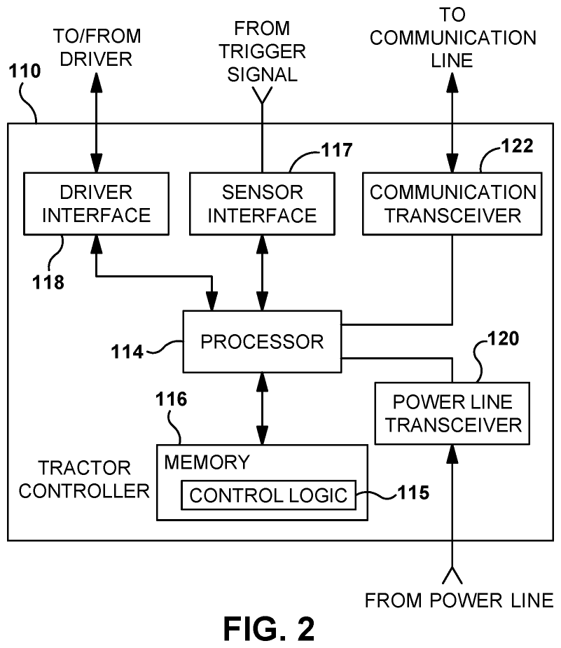

Referring to FIG. 2, a schematic block diagram of the tractor controller 110 is illustrated. The tractor controller 110 includes a processor 114 that executes instructions of control logic 115 stored in an internal memory 116, external memory (not shown), or a combination thereof. The processor 114 may comprise any type of technology. For example, the processor 114 may comprise a general-purpose electronic processor. Other types of processors and technologies are possible. The internal memory 116 may comprise any type of technology. For example, the internal memory 116 may comprise random access memory (RAM), read only memory (ROM), solid state memory, or any combination thereof. Other types of memories and data storage technologies are possible.

The tractor controller 110 also includes a vehicle sensor interface 117 that may comprise any type of technology. The sensor interface 117 enables communication between the processor 114 and vehicle sensors such as wheel speed sensors, pressure sensors, acceleration sensors (i.e., accelerometers), and steering angle sensors, for example. Other types of vehicle sensors and technologies are possible.

The tractor controller 110 further includes a vehicle driver interface 118 that may comprise any type of technology. For example, the driver interface 118 may comprise a keypad, a keyboard, a touch-sensitive display screen, a liquid crystal display (LCD) screen, a microphone, a speaker, or any combination thereof. Other types of driver devices and technologies are possible.

A power line transceiver 120 enables the processor 114 to send/receive signals to/from the power line 12. Similarly, a communication line transceiver 122 enables the tractor controller 110 to send/receive signals to/from the communication line 14. Structure and operation of transceiver circuits are known and, therefore, will not be described. The transceiver circuits may send/receive signals based upon any type of network communication of the communication line 14.

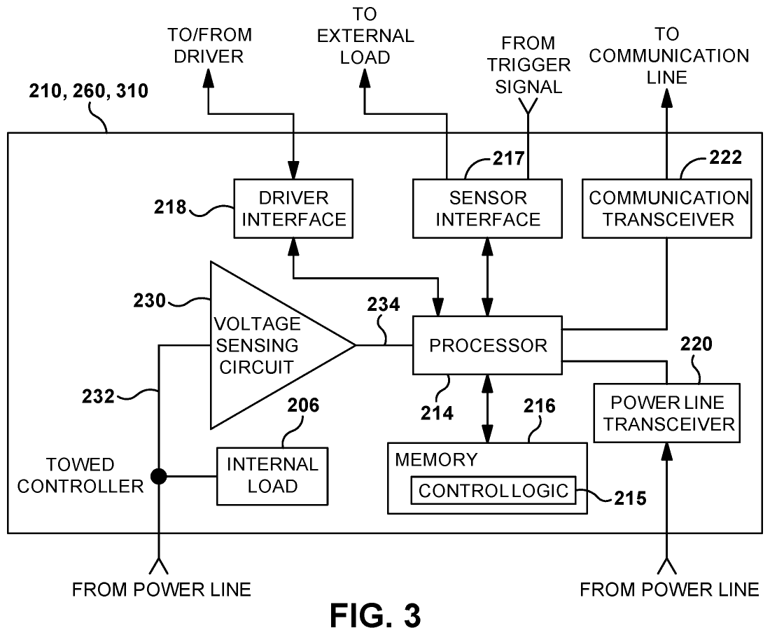

Referring to FIG. 3, a schematic block diagram of each of the first, second, and third towed controllers 210, 260, 310 is illustrated. Each of the first, second, and third towed controllers 210, 260, 310 may comprise components similar to components of the tractor controller 110 described hereinabove. Each of the first, second, and third towed controllers 210, 260, 310 is constructed and operates in similar manner. For simplicity and purpose of explanation, components and operation of only the first towed controller 210 are described with reference to FIG. 3.

As shown in FIG. 3, the first controller 210 includes a processor 214 that executes instructions of control logic 215 stored in an internal memory 216, external memory (not shown), or a combination thereof. The processor 214 may comprise any type of technology. For example, the processor 214 may comprise a general-purpose electronic processor. Other types of processors and technologies are possible. The internal memory 216 may comprise any type of technology. For example, the internal memory 216 may comprise random access memory (RAM), read only memory (ROM), solid state memory, or any combination thereof. Other types of memories and data storage technologies are possible.

The first controller 210 also includes a vehicle sensor interface 217 that may comprise any type of technology. The sensor interface 217 enables communication between the processor 214 and vehicle sensors such as wheel speed sensors, pressure sensors, acceleration sensors (i.e., accelerometers), and steering angle sensors, for example. Other types of vehicle sensors and technologies are possible.

The first controller 210 further includes a vehicle driver interface 218 that may comprise any type of technology. For example, the driver interface 218 may comprise a keypad, a keyboard, a touch-sensitive display screen, a LCD screen, a microphone, a speaker, or any combination thereof. Other types of driver devices and technologies are possible.

A power line transceiver 220 enables the processor 214 to send/receive signals to/from the power line 12. Similarly, a communication line transceiver 222 enables the processor 214 to send/receive signals to/from the communication line 14. Structure and operation of transceiver circuits are known and, therefore, will not be described. The transceiver circuits may send/receive signals based upon any type of network communication of the communication line 14.

The first controller 210 also includes an internal load 206 to which voltage from the power line 12 in vicinity of the first controller 210 can be applied. The internal load 206 may comprise a solenoid-type of load, for example. Other types of loads are possible.

A voltage sensing circuit 230 senses on input line 232 the voltage across the internal load 206, and provides on output line 234 an output voltage signal to the processor 214 for further processing. The voltage sensing circuit 230 may comprise an analog-to-digital voltage converter with a sample-and-hold, for example. Structure and operation of voltage sensing circuits are known and conventional and, therefore, will not be described.

In an example implementation, the first controller 210 is arranged to measure voltage of the power line 12 in vicinity of the first controller 210, and then transmit the measured voltage along the communication line 14 to other controllers of the vehicle train 1 (shown in FIG. 1). The other controllers to which the measured voltage of the power line 12 in vicinity of the first controller 210 is transmitted include, but are not limited to, the tractor controller 110, the second controller 260, and the third controller 310 (all shown in FIG. 1A). Identification information such as an identification number associated with the first towed vehicle 200, and thus also associated with the first controller 210, is also transmitted to the other controllers.

The voltage of the power line 12 in vicinity of the first controller 210 is measured by applying a load that includes a combination of the internal load 206 (FIG. 3) and the external load 202 (FIG. 1A). The first controller 210 is triggered by the trigger signal 204 to measure voltage across the combination of the internal load 206 and the external load 202. The trigger signal 204 at the first controller 210 may originate from the control logic 115 (FIG. 2) of the tractor controller 110, and transmit via the communication line 14 to the first controller 210. A trigger signal originating from the tractor controller 110 (shown as trigger signal 104 in FIG. 1A) may be provided in response to a vehicle driver operating a manual switch or operating a brake-pedal switch, for example. Alternatively, the trigger signal 204 may originate from the control logic 215 (FIG. 3) of the first controller 210.

A trigger signal, whether originating from the control logic 115 of the tractor controller 110 or from the control logic 215 of the first controller 210, is an external means to start the voltage measuring process. When triggered, the combination of the internal load 206 and the external load 202 is connected as a momentary load to the power line 12 to induce a voltage drop from line losses at input of the first controller 210. The voltage drop is then measured by components of the first controller 210.

The second controller 260 is arranged to measure voltage of the power line 12 in vicinity of the second controller 260, and then transmit the measured voltage along the communication line 14 to other controllers of the vehicle train 1. The other controllers to which the measured voltage of the power line 12 in vicinity of the second controller 260 is transmitted include, but are not limited to, the tractor controller 110, the first controller 210, and the third controller 310. Identification information such as an identification number associated with the second towed vehicle 250, and thus also associated with the second controller 260, is also transmitted to the other controllers.

The voltage of the power line 12 in vicinity of the second controller 260 is measured by applying a load that includes a combination of an internal load (which is like the internal load 206 shown in FIG. 3) and the external load 252 (FIG. 1A). The second controller 260 is triggered by the trigger signal 254 to measure voltage across the combination of internal and external loads. The trigger signal 254 at the second controller 260 may originate from the control logic 115 of the tractor controller 110, and transmit via communication line 14 to the second controller 260 in the same manner as described hereinabove for the first controller 210.

Similarly, the third controller 310 is arranged to measure voltage of the power line 12 in vicinity of the third controller 310, and then transmit the measured voltage along the communication line 14 to other controllers of the vehicle train 1. The other controllers to which the measured voltage of the power line 12 in vicinity of the third controller 310 is transmitted include, but are not limited to, the tractor controller 110 and the first and second controllers 210, 260. Identification information such as an identification number associated with the second trailer 300, and thus also associated with the third controller 310, is also transmitted to the other controllers.

The voltage of the power line 12 in vicinity of the third controller 310 is measured by applying a load that includes a combination of an internal load (which is like the internal load 206 shown in FIG. 3) and the external load 302 (FIG. 1A). The third controller 310 is triggered by the trigger signal 304 to measure voltage across the combination of internal and external loads. The trigger signal 304 at the third controller 310 may originate from the control logic 115 of the tractor controller 110, and transmit via communication line 14 to the third controller 310 in the same manner as described hereinabove for the first controller 210.

It should be apparent that control logic 215 (FIG. 3) of the first controller 210 enables the first controller 210, when triggered, to not only transmit a measured voltage but also an identification number that identifies the first towed vehicle 200 from which the measured voltage is transmitted. Control logic (not shown) of the second controller 260 enables the second controller 260, when triggered, to not only transmit a measured voltage but also an identification number that identifies the second towed vehicle 260 from which the measured voltage is transmitted. Similarly, control logic (also not shown) of the third controller 310 enables the third controller 310, when triggered, to not only transmit a measured voltage but also an identification number that identifies the third towed vehicle 300 from which the measured voltage is transmitted.

The tractor controller 110 receives the measured voltages from the first, second, and third controllers 210, 260, 310, as well as measured voltages from other controllers of other towed vehicles that may be in tow by the tractor 100. The control logic 115 of the tractor controller 110 then determines order of all towed vehicles including the first, second, and third towed vehicles 200, 260, 300 relative to the tractor 100 based upon measured voltages received from all towed controllers. It is assumed that the lowest measured voltage corresponds to the towed vehicle farthest from the tractor 100, and the highest measured voltage corresponds to the towed vehicle closest to the tractor 100. The ranking of the order of the towed vehicles relative to the tractor 100 and, thus also relative to each other, allows the tractor controller 110 to provide various vehicle control functions that are based upon knowing the order of all of the towed vehicles including the first, second, and third towed vehicles 200, 260, 300 in tow by the tractor 100.

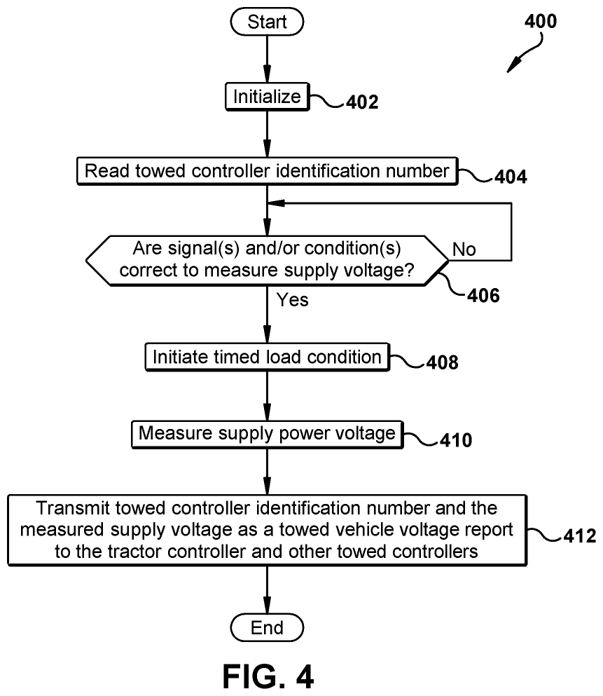

Referring to FIG. 4, a flow diagram 400 depicts an example method of operating the first controller 210 (and therefore also an example method of operating the second and third controllers 260, 310) of FIG. 3 in accordance with an embodiment. The flow diagram 400 is an embodiment of the control logic 215 shown in FIG. 3, and will be referred to herein as “control logic 215”.

The control logic 215 in block 402 begins with an initialization before proceeding to block 404 in which an identification number associated with the first controller 210 is read. The process then proceeds to block 406 in which a determination is made as to whether one or more signals and/or one or more conditions are correct to measure the supply voltage on power line 12 in vicinity of the first controller 210.

Examples of one or more signals and/or one or more conditions to be checked for correctness include the following list:

Is a wheel sensor zero or below a minimum measurable speed?

Is parking brake released or applied as set by configuration?

Is trailer controller running within time limit of power on reset?

Is a pneumatic braking signal within a predetermined pressure/force?

Is an electrical braking signal received from another controller?

Other one or more signals and/or one or more conditions to check for correctness are possible for block 406 in the flow diagram 400 of FIG. 4.

If the determination in block 406 is negative (i.e., the one or more signals and/or one or more conditions are not correct), the process returns back to block 406 to continue monitoring for correctness of the one or more signals and/or the one or more conditions. However, if the determination in block 406 is affirmative (i.e., the one or more signals and/or one or more conditions are correct), the process proceeds to block 408.

In block 408, supply voltage from power line 12 is applied to the combination of the internal load 206 and the external load 202 to initiate a timed load condition. The process proceeds to block 410 in which the supply voltage of the power line 12 in vicinity of the first controller 210, and therefore also in vicinity of the first towed vehicle 200, is measured. Then in block 412, the identification number obtained in block 404 and the measured voltage obtained in block 410 are transmitted together as a towed vehicle voltage report from the first controller 210 via the communication line 14 to the tractor controller 110 and other towed vehicle controllers including the second and third controllers 260, 310. The process of control logic 215 then ends.

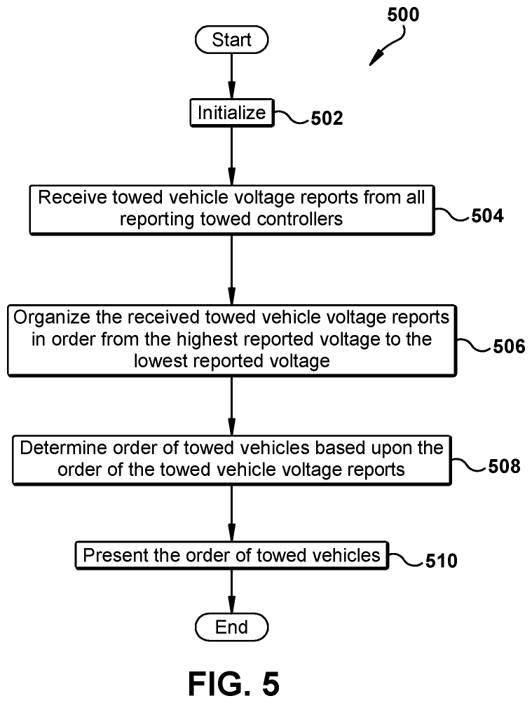

Referring to FIG. 5, a flow diagram 500 depicts an example method of operating the tractor controller 110 of FIG. 2 in accordance with an embodiment. The flow diagram 500 is an embodiment of the control logic 115 shown in FIG. 2, and will be referred to herein as “control logic 115”.

The control logic 115 in block 502 begins with an initialization before proceeding to block 504 in which towed vehicle voltage reports are received from all reporting towed controllers including the first, second, and third controllers 210, 260, 310. Then in block 506, the towed vehicle voltage reports are organized in order (i.e., ranked) from the highest reported voltage to the lowest reported voltage. The process then proceeds to block 508.

In block 508, an order of the towed vehicles is determined based upon the order of the towed vehicle voltage reports. The process proceeds to block 510 in which the order of the towed vehicles is presented. As an example, the order of the towed vehicles may be presented on a visual display located in the cab compartment of the tractor 100. The process of control logic 115 then ends.

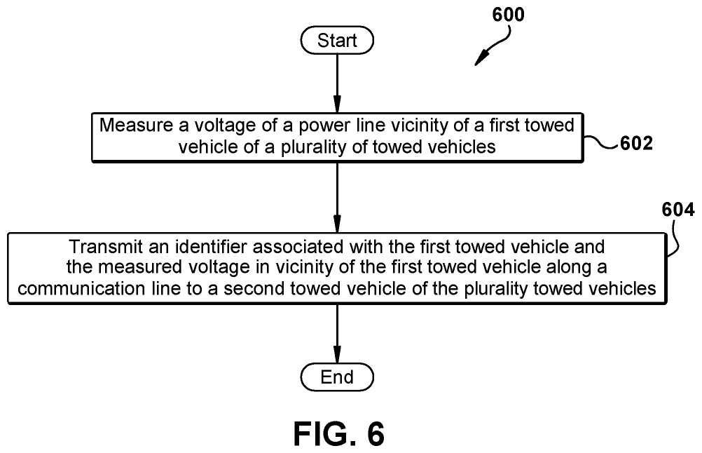

Referring to FIG. 6, a flow diagram 600 depicts a method of operating the vehicle train 1 of FIG. 1 in accordance with an embodiment. In block 602, a voltage of a power line in vicinity of a first towed vehicle of a plurality of towed vehicles is measured. The process proceeds to block 604 in which an identifier associated with the first towed vehicle and the measured voltage in vicinity of the first towed vehicle are transmitted along a communication line to a second towed vehicle of the plurality towed vehicles. The process then ends.

In some embodiments, a load is connected to the power line to allow voltage across the load to be measured and thereby to provide the measured voltage of the power line in vicinity of the first towed vehicle. In some embodiments, the load is connected to the power line in response to a trigger signal from a tractor.

In some embodiments, a voltage of a power line in vicinity of the second towed vehicle of the plurality of towed vehicles is measured, and an identifier associated with the second towed vehicle and the measured voltage in vicinity of the second towed vehicle are transmitted along the communication line to the first towed vehicle of the plurality towed vehicles.

In some embodiments, the method is performed by a controller having a memory executing one or more programs of instructions which are tangibly embodied in a program storage medium readable by the controller.

It should be apparent that the control logic 215 enables the first controller 210 to determine power supply signal information (i.e., the drop in voltage of the power line 12 as measured in vicinity of the first controller 210), and then to transmit the power supply signal information to the tractor controller 110 and other trailer controllers including the second and third controllers 260, 310 of the second and third trailers 250, 300. Thus, not only does the controller of each trailer transmit a measured voltage associated with that particular controller, but the controller also receives measured voltages from controllers of all other towed vehicles that are in tow by the tractor 100.

It should also be apparent that the control logic 115 of the tractor controller 110, the control logic 215 of the first controller 210, and control logic from all other towed controllers including the second and third controllers 260, 310 are integrated into a practical application of providing a useful and reliable report of the order of all of the towed vehicles including the first, second, and third towed vehicles 200, 250, 300 that are in tow by the tractor 100.

A number of advantages result by providing a vehicle with the above-described control apparatus 10 of FIG. 1A to provide the capability for either the vehicle driver to trigger the voltage measurement process to determine towed vehicle order or the control logic of the controller of a particular towed vehicle (e.g., the control logic 215 of the first controller 210 of the first trailer 200) to trigger the voltage measurement process to self-determine its towed vehicle position in the order of towed vehicles. One advantage is that the tractor controller 110 can use the order of the towed vehicles to better perform other vehicle functions. Another advantage is ability is provided to send braking requests to any number of specific axles or axle groups on any number of specific towed vehicles.

Program instructions for enabling each of the controllers 110, 210, 260, 310 (FIG. 1A) to perform operation steps in accordance with corresponding flow diagrams may be embedded in memory internal to each respective controller. Alternatively, or in addition to, program instructions may be stored in memory external to each respective controller. As an example, program instructions may be stored in memory internal to a different controller of the vehicle. Program instructions may be stored on any type of program storage media including, but not limited to, external hard drives, flash drives, and compact discs. Program instructions may be reprogrammed depending upon features of the particular controller.

Aspects of disclosed embodiments may be implemented in software, hardware, firmware, or a combination thereof. The various elements of the system, either individually or in combination, may be implemented as a computer program product tangibly embodied in a machine-readable storage device for execution by a processor. Various steps of embodiments may be performed by a computer processor executing a program tangibly embodied on a computer-readable medium to perform functions by operating on input and generating output. The computer-readable medium may be, for example, a memory, a transportable medium such as a compact disk or a flash drive, such that a computer program embodying aspects of the disclosed embodiments can be loaded onto a computer.

Although the above description describes use of only one controller in the tractor 100 and only one controller in each of the dolly 250 and the first and second trailers 200, 300, it is conceivable that any number of controllers may be used. Moreover, it is conceivable that any type of controller may be used. Suitable controllers for use in vehicles are known and, therefore, have not been described. Accordingly, the program instructions of the present disclosure can be stored on program storage media associated with one or more vehicle controllers.

While the present invention has been illustrated by the description of example processes and system components, and while the various processes and components have been described in detail, applicant does not intend to restrict or in any way limit the scope of the appended claims to such detail. Additional modifications will also readily appear to those skilled in the art. The invention in its broadest aspects is therefore not limited to the specific details, implementations, or illustrative examples shown and described. Accordingly, departures may be made from such details without departing from the spirit or scope of applicant's general inventive concept.

What is claimed is:

1. A control apparatus for a vehicle train having a tractor and first and second towed vehicles in tow by the tractor, the control apparatus comprising:
a first controller associated with the first towed vehicle and arranged to (i) measure voltage of a power line in vicinity of the first towed vehicle, and (ii) transmit the measured voltage along a communication line to other controllers of the vehicle train.

2. A control apparatus according to claim 1, wherein the first controller is arranged to transmit identification information associated with the first towed vehicle to other controllers of the vehicle train.

3. A control apparatus according to claim 1 further comprising:
a load connectable to the power line to allow voltage across the load to be measured.

4. A control apparatus according to claim 3, wherein the first controller is responsive to a trigger signal from a controller of the tractor to connect the load to the power line and thereby to allow voltage across the load to be measured.

5. A control apparatus according to claim 3, wherein the load comprises an energizeable solenoid.

6. A control apparatus according to claim 3, wherein the load includes a combination of an internal load and an external load.

7. A control apparatus according to claim 1 further comprising:
a second controller associated with the second towed vehicle and arranged to (i) measure voltage of a power line in vicinity of the second towed vehicle, and (ii) transmit the measured voltage along a communication line to other controllers of the vehicle train.

8. A control apparatus according to claim 7, wherein the first controller is arranged to transmit identification information associated with the first towed vehicle to other controllers of the vehicle train, and the second controller is arranged to transmit identification information associated with the second towed vehicle to other controllers of the vehicle train.

9. A control apparatus according to claim 7, wherein the first controller is responsive to a trigger signal provided by a controller of the tractor to connect a first load to the power line and thereby to allow voltage across the first load to be measured, and the second controller is responsive to a trigger signal provided by the tractor controller to connect a second load to the power line and thereby to allow voltage across the second load to be measured.

10. A control apparatus according to claim 7, wherein the first controller is responsive to a trigger signal provided by the first controller to connect a first load to the power line and thereby to allow voltage across the first load to be measured, and the second controller is responsive to a trigger signal provided by the second controller to connect a second load to the power line and thereby to allow voltage across the second load to be measured.

11. A multiple-trailer combination of a tractor-trailer vehicle, comprising:
a power line;
a communication line;
a first towed vehicle including a first processor connected to the power line and connected to the communication line; and
a second towed vehicle including a second processor connected to the power line and connected to the communication line;
wherein each of the first and second processors is programmed to (i) measure voltage of the power line in vicinity of its respective towed vehicle, and (ii) transmit the measured voltage across the communication line to the processor of the other towed vehicle.

12. A multiple-trailer combination of a tractor-trailer vehicle according to claim 11, wherein the first towed vehicle comprises a first trailer, and the second towed vehicle comprises a dolly.

13. A multiple-trailer combination of a tractor-trailer vehicle according to claim 12 further comprising:
a third towed vehicle including a third processor connected to the power line and connected to the communication line, wherein (i) the third towed vehicle comprises a second trailer, and (ii) the dolly interconnects the first and second trailers.

14. A multiple-trailer combination of a tractor-trailer vehicle according to claim 11, wherein each of the first and second processors is further programmed to transmit identification information associated with its respective processor across the communication line to the processor of the other towed vehicle.

15. A multiple-trailer combination of a tractor-trailer vehicle according to claim 11, wherein the power line comprises the communication line.

16. A multiple-trailer combination of a tractor-trailer vehicle according to claim 11 further comprising:
a tractor processor connected to the power line, connected to the communication line, and programmed to receive measured voltages transmitted from the first and second processors.

17. A multiple-trailer combination of a tractor-trailer vehicle according to claim 16, wherein the tractor processor is further programmed to determine order of the first and second towed vehicles relative to the tractor based upon measured voltages received from the first and second processors.

18. A method of operating a vehicle train having a tractor and a plurality of towed vehicles in tow by the tractor, the method comprising:
measuring a voltage of a power line in vicinity of a first towed vehicle of the plurality of towed vehicles; and
transmitting an identifier associated with the first towed vehicle and the measured voltage in vicinity of the first towed vehicle along a communication line to at least a second towed vehicle of the plurality towed vehicles.

19. A method according to claim 18 further comprising:
connecting a load to the power line to allow voltage across the load to be measured and thereby to provide the measured voltage of the power line in vicinity of the first towed vehicle.

20. A method according to claim 19, wherein connecting a load to the power line to allow voltage across the load to be measured and thereby to provide the measured voltage of the power line in vicinity of the first towed vehicle includes:
connecting the load to the power line in response to a trigger signal from the tractor.

21. A method according to claim 18 further comprising:
measuring a voltage of a power line in vicinity of the second towed vehicle of the plurality of towed vehicles; and
transmitting an identifier associated with the second towed vehicle and the measured voltage in vicinity of the second towed vehicle along the communication line to the first towed vehicle of the plurality towed vehicles.

22. A method according to claim 18, wherein the method is performed by a controller having a memory executing one or more programs of instructions which are tangibly embodied in a program storage medium readable by the controller.
